(19) United States
(12) Patent Application Publication
(10) Pub. No.: US 2025/0126688 A1
(43) Pub. Date: Apr. 17, 2025

(54) CONTINUOUS MICROWAVE CURING SYSTEM AND PROCESS

(71) Applicants: Min-Hang WENG, Kaohsiung City (TW); Meilin Holdings Limited, Kaohsiung City (TW)

(72) Inventors: Ru-Yuan YANG, Kaohsiung City (TW); Min-Hang WENG, Kaohsiung City (TW)

(21) Appl. No.: 18/635,714

(22) Filed: Apr. 15, 2024

(30) Foreign Application Priority Data
Oct. 13, 2023 (TW) 112139506

(51) Int. Cl. H05B 6/78

(52) U.S. Cl. CPC H05B 6/78

(57) ABSTRACT

A continuous microwave curing system, includes a heating cavity with a microwave power source and an inlet opening and an outlet opening on opposite sides; a first microwave suppression cavity, connected to the inlet opening of the heating cavity; a second microwave suppression cavity, connected to the outlet opening of the heating cavity; a conveyor belt, used to transport a laminated structure that needs to be heated by microwave power; wherein the laminated structure includes at least one adhesive and two layers of objects, the adhesive is placed between the two layers of objects. A continuous microwave curing process includes placing an adhesive between two layers of objects to form a laminated structure and using a conveyor belt to send the laminated structure into a heating cavity for heating with microwave power for a period of time, so that the temperature of the adhesive reaches above 60 degrees.

### TECHNICAL FIELD

The present invention relates to a microwave curing system and process, and more particularly, to a continuous microwave curing system and process that can rapidly heat and solidify laminated structures of different sizes.

### BACKGROUND

Many processes that require different materials to be bonded require the use of adhesive to be applied to the surface of the object, and sit for a period of time and then bond to the surface of another object. Or, after applying adhesive on the surface of the two objects to be bonded, they can be stacked and pressed to be heated for a period of time. But overall, it takes some time to fit, and thus is time-consuming for mass-produced items extremely. For example, in the traditional shoemaking process, since the midsole and the outsole cannot be integrally formed, adhesive must be used to bond them. In conventional technology, when the midsole of a shoe is attached to the outsole of a shoe, it is necessary to apply adhesive on both sides of the corresponding bonding point. Since a lot of manual work is required to apply adhesive, it is quite labor-intensive and time-consuming. Moreover, when too much adhesive is applied, the adhesive soles are likely to have residual glue, which will affect the appearance; when too little adhesive is applied, the bonding properties between the midsole and the outsole are too poor, causing the them to separate and reduce the service life of the shoes. Since the adhesive is sticky, it is easy to stick to equipment or other materials, reducing the ease of operation of the equipment, and thus cause great losses to manufacturers and increase production costs. In the shoemaking industry, the weight of the adhesive for shoes accounts for less than 2% of the shoes, but its performance affects the overall function of the shoes. In addition, in the current shoemaking industry, most shoemaking processes are developing towards water-based, environmentally friendly adhesives.

Traditional heating methods, such as flame, hot air, electric heating, steam, etc., all use the principle of heat conduction to transfer heat from the outside of the heated object to the inside, gradually increasing the center temperature of the object. It takes a certain amount of time for the center of the substance to reach the desired temperature, and it will take longer for objects with poor thermal conductivity.

Microwave is an electromagnetic wave with a frequency of 300 MHz to 300 GHz. In recent years, it has also been used in various industries and agriculture for heating, drying, cracking or solidifying substances. Commonly used frequencies of microwave power are 915 MHz and 2450 MHZ, which can cause the molecules of polar substances to rub against each other to generate heat. During use, one can choose microwave power and the processing time according to the shape, size and moisture content of the heating material. Microwave heating is a process in which the object to be heated becomes a heating element without the need for heat conduction. The inside and outside of the object are heated at the same time, so the heating effect can be achieved in a short time. And when microwave heating occurs, electromagnetic waves can usually penetrate all parts of the object evenly and generate heat, so the uniformity is greatly improved. In microwave heating, microwave energy can only be absorbed by the heated object to generate heat. Neither the air in the heating room nor the corresponding container will generate heat, so the thermal efficiency is extremely high and the production environment is significantly improved. In mass production, the use of microwave heating methods with continuous inlet and outlet can further increase the production capacity of objects. However, the opening of traditional continuous microwave heating machines is usually within 5 cm, which cannot meet the needs of objects of different sizes and having materials that need to be heated and cured inside.

In view of the above problems, it is necessary to propose a continuous curing system and process that can save manpower and is safe, which can quickly heat and solidify objects of different sizes and having materials that need to be heated and cured inside to solve the above problems . . .

### SUMMARY

The main purpose of the present invention is to propose a continuous microwave curing system that can continuously feed and discharge materials, which can quickly heat and solidify the laminated structures of different sizes, enter and exit the microwave heating cavity, so that they can be heated and solidified uniformly and quickly, finally, can be smooth and safe to use.

The secondary purpose of the present invention is to propose a continuous microwave curing process that can quickly solidify the laminated structures using environmentally friendly adhesives to adhere to different objects, and can allow laminated structures of different sizes to be cured in the microwave Continuous feeding of materials under the action of power achieves a safe process that saves manpower and quickly fits the upper and lower layers of materials.

In order to achieve the main goal of the invention, the invention proposes a continuous microwave curing system including:
a heating cavity, with a microwave power source in the heating cavity and an inlet opening and an outlet opening on opposite sides;
a first microwave suppression cavity, connected to the inlet opening of the heating cavity, and containing a plurality of suppression structures;
a second microwave suppression cavity, connected to the outlet opening of the heating cavity, and containing a plurality of suppression structures;
a conveyor belt, used to transport a laminated structure that needs to be heated by microwaves, enter the first microwave suppression cavity, then enter the heating cavity to heat with microwave power for a period of time, and finally enter the second microwave suppression cavity and output; and
a microwave absorbing structure, disposed above inside the interior of the first microwave suppression cavity or the second microwave suppression cavity, and containing at least one microwave absorbing material;
wherein, the laminated structure includes at least one adhesive and two layers of objects, and the adhesive is placed between the two layers of objects.

According to one feature of the invention, the continuous microwave curing system further includes a front operation module, and the front operation module includes:
a placement mechanism for placing the adhesive between the two layers of objects to form the laminated structure; and
a fixing mechanism for fixing the laminated structure to prevent the adhesive from being misaligned with the two layers of objects.

According to one feature of the invention, the wave absorbing structure is disposed above inside the first microwave suppression cavity and the second microwave suppression cavity, and has a plurality of fluid pipelines, which there are microwave absorbing materials inside these fluid pipelines.

According to one feature of the invention, a soft conductive material is provided on the outermost side of the first microwave suppression cavity and dropped down, and two ends of the outermost side of the second microwave suppression cavity are provided with the soft conductive material is lowered down.

According to one feature of the invention, a first soft conductive material is provided is suspended at the joint between the first microwave suppression cavity and the joint between the second microwave suppression cavity and the heating cavity.

In order to achieve another goal of the invention, the invention proposes a continuous microwave curing process includes the following steps of:
placing an adhesive between two layers of objects to form a laminate structure; and
using a conveyor belt to send the laminated structure into a heating cavity for heating with microwave power for a period of time, so that the temperature of the adhesive reaches above 60 degrees.

In view of the above problems, the continuous microwave curing process further includes steps of: fixing the laminated structure to prevent misalignment between the adhesive and the two layers of objects.

In view of the above problems, the microwave power is between 3 kw and 18 kw, and the period of time is between 10 seconds and 3 minutes.

In view of the above problems, the adhesive is a hot melt adhesive.

In view of the above problems, the adhesive is a moisture curing reactive polyurethane hot melt adhesive.

In summary, the continuous microwave curing system and process of the present invention have the following effects of:
1. being easy to manufacture and integrate;
2. letting the laminated structures smoothly enter and exit the microwave cavity;
3. having the microwave energy safety value;
4. using environmentally friendly adhesive materials;
5. rapidly heating and solidifying the laminated structure;
6. heating evenly the adhesive in the laminated structure.

### BRIEF DESCRIPTION OF THE DRAWINGS

In order to make the above-mentioned and other purposes, features, and advantages of the present invention more obvious and understandable, several preferred embodiments are specifically described below, and in conjunction with the accompanying drawings, the detailed description is as follows.

FIG. 1 is a schematic structural side view of an embodiment of a continuous microwave curing system.

FIG. 2 is a schematic side view of the structure of the first microwave suppression cavity embodiment of the continuous microwave curing system of the present invention.

FIG. 3 is a schematic structural side view of the second microwave suppression cavity embodiment of the continuous microwave curing system of the present invention.

FIG. 4 is a flow chart of the continuous microwave curing process of the present invention.

### DETAILED DESCRIPTION

The present inventions now will be described more fully hereinafter with reference to the accompanying drawings, in which some, but not all embodiments of the inventions are shown. Indeed, these inventions may be embodied in many different forms and may not be construed as limited to the embodiments set forth herein; rather, these embodiments are provided, so that this disclosure will satisfy applicable legal requirements.

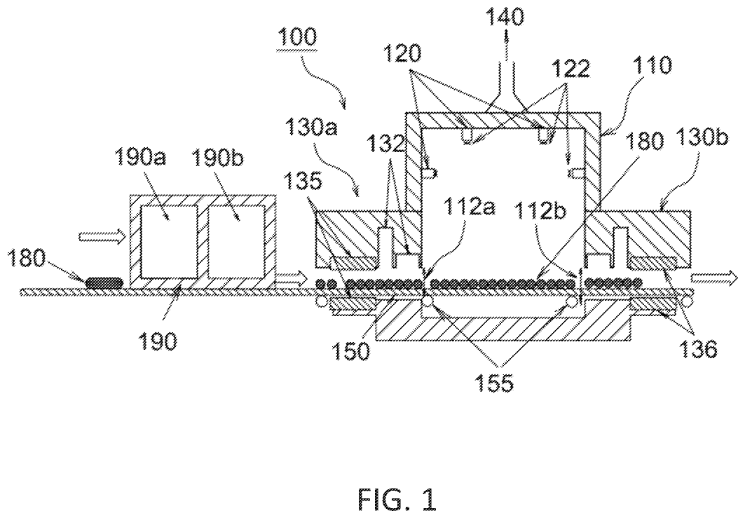

Please refer to FIG. 1, which is a schematic structural side view of an embodiment of the continuous microwave curing system 100. The continuous microwave curing system 100 mainly includes: a heating cavity 110, a first microwave suppression cavity 130a, a second microwave suppression cavity 130b and a conveyor belt 150. The black arrow in the FIG. 1 indicates the traveling direction of a laminated structure 180. The continuous microwave curing system 100 further includes: a front operation module 190 and an exhaust module 140.

The laminated structure 180 includes at least one adhesive and two layers of objects. The adhesive is placed between the two layers of objects located on the upper and lower layer of the two layers of objects. The two layers of objects can be of homogeneous material or heterogeneous materials. The adhesive may be in the form of a sheet, a solid state, a viscous state, a liquid state, or other forms. The adhesive includes yellow paste (chloroprene CR), syrup paste (grafted CR-grafted), solvent-based polyurethane adhesive, hot melt adhesive, etc.

Microwaves have different effects on materials of different properties, and are beneficial to heating, drying and curing operations. Because polar molecules absorb microwaves best, parts with high polarity absorb more microwave power than parts with lower polarity. This is the characteristic of selective heating. Therefore, in order to subject the adhesive to microwave heating, the adhesive needs to have good microwave absorption characteristics, so the adhesive can be added with a microwave absorbing material with a weight percentage of between 0.1% and 5%. The absorbing material for the addition of the adhesive is selected from one of carbon black, silicon carbide, activated carbon, and oxide material metal particles. Preferably, the adhesive is a hot melt adhesive. The basic resins used in the hot melt adhesive include polyurethane (PU), polyamide (PA), polyethylene (PE), ethylene/vinyl acetate (EVA), etc., The basic resins used in the hot melt adhesive also include biodegradable hot melt adhesives, such as polylactic acid type, polyesteramide type, polyhydroxyalkanoate type and natural polymer type, etc. PA type hot melt adhesive uses polyamide as the main raw material and has very strong bonding fastness to textiles and fibers. More preferably, the adhesive is a water-based PU (Polyurethan, PU) adhesive, or a PUR moisture-hardening polyurethane hot melt adhesive (Polyurethane Reactive, PUR). The viscosity of the adhesive in this invention is between 8000-10000 cps.

The two layers of objects are selected from one of porous materials such as wood, leather, fabric, paper, and ceramics, and objects such as plastic, metal, glass, and rubber. Preferably, in one embodiment, the two layers of objects are selected from the group consisting of Phylon soles, EVA soles, RB rubber soles, PU soles, TPU soles, PVC soles, TPR soles, genuine leather soles, plastic soles, SBR soles, and ABS soles. It should be noted that the laminated structure 180 has at least one adhesive and two layers of objects and the height of the laminated structure 180 can be between 1 cm and 30 cm. For example, the two layers of objects of the laminated structure 180 are the upper sole, midsole or lower sole of the shoe. The laminated structure 180 in the shoe is located below the shoe and the shoe with the laminated structure 180 is completely sent into the interior of the heating cavity 110.

The front operation module 190 includes a placement mechanism 190a and a fixing mechanism 190b. The placement mechanism 190a is used to place the adhesive between the two layers of objects to form the laminated structure 180. The placement mechanism 190a places the adhesive between the two layers of objects by coating the adhesive, spraying the adhesive, screen printing the adhesive, rolling the adhesive, depositing the adhesive, making the adhesive between two layers of objects to form the laminated structure 180. The fixing mechanism 190b is used to fix the laminated structure 180 to prevent the adhesive from being misaligned with the two layers of objects. For example, the fixing mechanism 190b can install a set of mold machines to the outside of the laminated structure 180 to fix the laminated structure 180, and the set of mold mechanisms can apply force to the laminated structure 180, and follow the laminated structure 180 to be sent into the heating cavity 110. Therefore, this set of mold mechanisms is mainly composed of materials that do not absorb microwaves, such as polypropylene (PP) or Teflon.

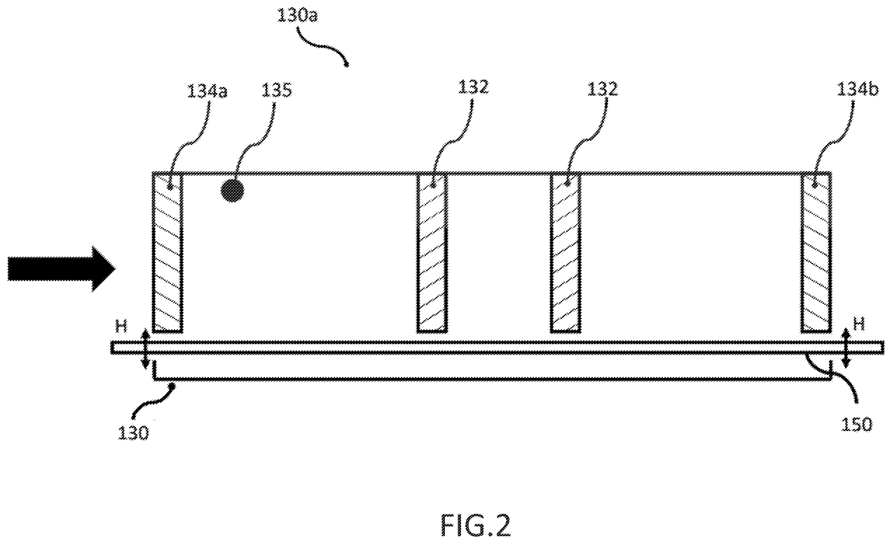

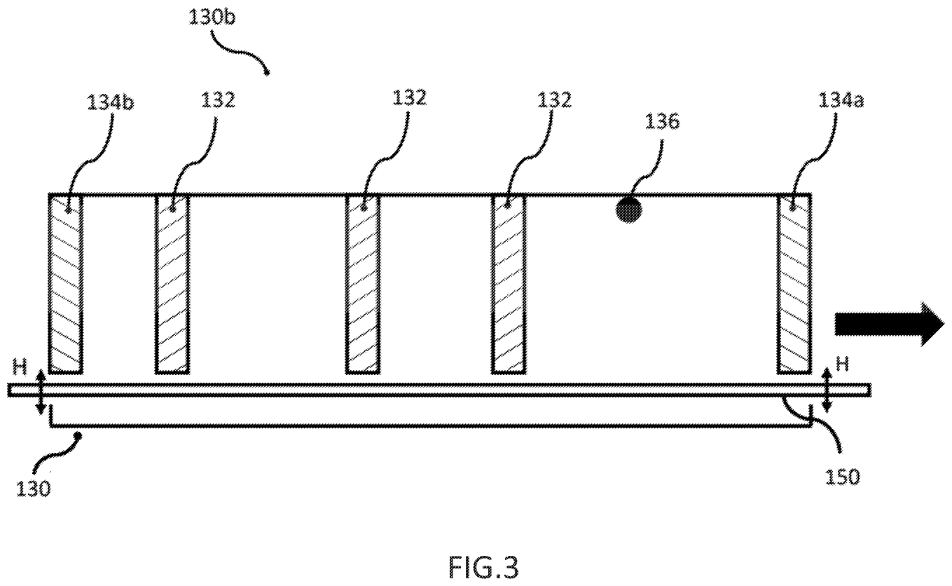

Please refer to FIG. 2, which is a schematic structural side view of the first microwave suppression cavity embodiment of the continuous microwave curing system of the present invention, and FIG. 3, which is a schematic structural side view of the second embodiment of the continuous microwave curing system of the present invention. It explains more clearly the implementation of the first microwave suppression cavity 130a and the second microwave suppression cavity 130b. The black arrow in the FIG. is the traveling direction of the laminated structure 180.

The heating cavity 110 has a plurality of microwave power sources 120 inside, and the heating cavity 110 has an inlet opening 112a and an outlet opening 112b on opposite sides, wherein the heights of the inlet opening 112a and the outlet opening 112b are from 5 cm to 50 cm. The microwave power sources 120 provide microwave power 122 into the heating cavity 110, and the microwave frequency of the microwave power sources 120 is selected from one of 915 MHz, 2450 MHz or 5800 MHZ. Since the heating cavity 110 has the inlet opening 112a and the outlet opening 112b, the heating cavity 110 needs to connect the first microwave suppression cavity 130a and the second microwave suppression cavity 130b to prevent microwave power (energy) from leaking out the inlet opening 112a and the outlet opening 112b of the heating cavity 110.

The first microwave suppression cavity 130a is docked with the inlet opening 112a of the heating cavity 110, and the first microwave suppression cavity 130a contains a plurality of suppression structures 132 inside; the second microwave suppression cavity 130b, connected to the outlet opening 112b of the heating cavity 110 contains a plurality of suppression structures 132 inside. The height H of the inlet opening 112a and the outlet opening 112b is between 5 cm and 50 cm. Preferably, the height of the inlet opening 112a and the outlet opening 112b is between 20 cm and 40 cm.

Due to the large height H of the inlet opening 112a and the outlet opening 112b, the laminated structure 180 can be of a large size, and the laminated structure 180 can be embedded in the shoe body. The laminated structure 180 with at least one adhesive and two layers of objects, which its adhesive is PUR, and its two layers are the sole and the midsole, respectively, attached to the bottom of the entire shoe body. The laminated structure 180 of different sizes can smoothly enter and exit the heating cavity 110 by the conveyor belt 150, to solve the typical problem, which typically may cause jamming or uneven arrangement, resulting in uneven heating or un-smooth discharging of the laminated structures 180.

The conveyor belt 150 is provided with rollers 155 at the bottom, which is used to transport the laminated structure 180 that needs to be heated by microwave power, enter the first microwave suppression cavity 130a, then enters the heating cavity 110 for microwave power heating for a period of time, and finally enter the second microwave suppression cavity 130b and output. Namely, the conveyor belt 150 carries the laminated structure 180 heated by microwave power. The conveyor belt 150 can be continuously conveyed or stepped conveyed. Continuous conveying means forward transmission at a fixed conveying speed; step-by-step conveying means that each conveying will advance a certain distance and stay for the period of time. The black arrow in the first picture is the direction of movement of the laminated structure 180.

The exhaust module 140 is connected to the heating cavity 110. If there is gas generated after the laminated structure 180 is heated, the exhaust module 140 can discharge the gas out of the heating cavity 110.

In FIGS. 2 and 3, the first microwave suppression cavity 130a and the second microwave suppression cavity 130b include a plurality of suppression structures 132. The suppression structures 132 are arranged on the microwave suppression cavities 130 from top to bottom. The suppression structures 132 can also be placed up, down, left, and right inside the microwave suppression cavities 130. It should be noted that the length of the suppression structures 132 is smaller than the height of the microwave suppression cavities 130 including the first microwave suppression cavity 130a and the second microwave suppression cavity 130b. Moreover, the suppression structures 132 do not contact the conveyor belt 150. Through the first microwave suppression cavity 130a and the second microwave suppression cavity 130b, the continuous microwave curing system 100 of the present invention can achieve microwave power (energy) safety values when using the laminate materials 180 of different sizes.

In one embodiment, the suppression structures 132 are in the shape of metal sheets, preferably in the shape of a plurality of metal sheets. In another embodiment, the suppression structures 132 are made of a soft material that can absorb microwave power, such as a soft material containing carbon. In one embodiment, the suppression structures 132 are made of soft material that can absorb microwave power on the entire surface, and are cut into multiple sections from bottom to top. That is to say, the suppression structures 132 are a whole piece of suppression structure, cut into multiple pieces, and hung from top to bottom between the first microwave suppression cavity 130a and the second microwave suppression cavity 130b. The laminated structure 180 when traveling by the conveyor belt 150 can push away the suppression structures 132 when the laminated structure 180 travels through the first microwave suppression cavity 130a and the second microwave suppression cavity 130b.

The outermost ends of the first microwave suppression cavity 130a and the second microwave suppression cavity 130b are provided with soft conductive materials 134a, which are hung between the first microwave suppression cavity 130a and the second microwave suppression cavity 130b vertically. Moreover, a soft conductive material 134b is provided is suspended at the joint between the first microwave suppression cavity 130a and the heating cavity 110; a soft conductive material 134b is also provided is suspended at the joint between the second microwave suppression cavity 130b and the heating cavity 110. The outermost ends of the first microwave suppression cavity 130a and the second microwave suppression cavity 130b are further provided with openable and closable metal gates (not shown in the FIG.). In one embodiment, the adhesive in the laminated structure 180 on the conveyor belt 150 is heated to a temperature above 60 degrees and below 120 degrees in the heating cavity 110. Preferably, the adhesive is heated to a temperature above 70 degrees and below 100 degrees in the heating cavity 110. Through this, the adhesive solidifies and adheres to the two-layer object, reaching a tensile strength of ≥100 kgf/cm².

In FIG. 2, a first microwave absorbing structure 135 is disposed above the interior of the first microwave suppression cavity 130a and has a plurality of fluid pipelines, and these fluid pipelines have microwave absorbing materials inside. The microwave absorbing material of the first microwave absorbing structure 135 absorbs the microwave power inside the first microwave suppressing cavity 130a. In one embodiment, the microwave absorbing material contained in the first wave absorbing structure 135 is selected from one of water, refrigerant or ionized water; in one embodiment, the microwave absorbing material contained in the first wave absorbing structure 135 is selected from one of carbon black, silicon carbide, and activated carbon; in one embodiment, the microwave absorbing material contained in the first wave absorbing structure 135 is an oxide material; in one embodiment, the microwave absorbing material is an oxide material contained in the first wave absorbing structure 135 is one of metal strips or metal particles.

In FIG. 3, a second microwave absorbing structure 136 is disposed above the interior of the second microwave suppression cavity 130b and has a plurality of fluid pipelines, and these fluid pipelines have microwave absorbing materials inside. The microwave absorbing material of the second microwave absorbing structure 136 absorbs the microwaves inside the second microwave suppressing cavity 130b. In one embodiment, the microwave absorbing material contained in the second wave absorbing structure 136 is selected from one of water, refrigerant or ionized water; in one embodiment, the microwave absorbing material contained in the second wave absorbing structure 136 is selected from one of carbon black, silicon carbide, and activated carbon; in one embodiment, the microwave absorbing material contained in the second microwave absorbing structure 136 is an oxide material; in one embodiment, the microwave absorbing material contained in the second microwave absorbing structure 136 is one of metal strips or metal particles.

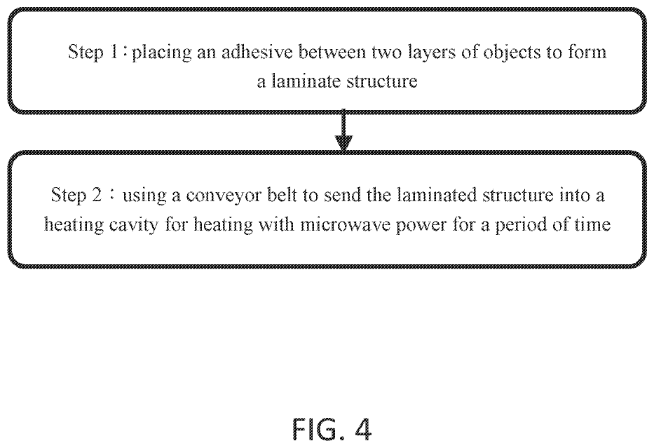

In conjunction with the contents described in FIGS. 1, 2, and 3, please refer to FIG. 4, which is a flow chart of the continuous microwave curing process of the present invention. A continuous microwave curing process includes the following steps of:
Step 1: placing an adhesive between two layers of objects to form a laminate structure; and
Step 2: using a conveyor belt to send the laminated structure into a heating cavity for heating with microwave power for a period of time, so that the temperature of the adhesive reaches above 60 degrees.

Wherein the continuous microwave curing process further includes steps of: fixing the laminated structure to prevent misalignment between the adhesive and the two layers of objects.

It should be noted that when microwave heating is performed on substances, it is paid to formulating a reasonable heating process. This is to prevent some substances from becoming more absorbent when the temperature is higher, causing a vicious cycle, causing local temperatures to rise sharply, resulting in overdrying or even carbonization. In other words, it will not work if the microwave power and microwave time are too large or too small. If the microwave power is too high, the temperature of the entire upper and lower layers of the laminated structure 180 and the adhesive will be too high, causing high-temperature cracking or deformation of the upper and lower layers of the object. If the microwave power is too small, the temperature of the adhesive of the laminated structure 180 is too low, so the upper and lower layers of objects cannot be cured. Since the height of the heating cavity 110 can reach 30 cm to 50 cm, it is very necessary to appropriately select the microwave power and the microwave heating period. In order to balance productivity and curing quality, the period of time during microwave heating in the heating cavity 110 of the present invention is between 10 seconds and 3 minutes, and the microwave power is between 3 kw and 18 kw. Preferably, the period of time during microwave heating in the heating cavity 110 is between 40 seconds and 1 minute, and the microwave power is between 4 kw and 9 kw.

In summary, the continuous microwave curing system and process of the present invention have the following effects of:
1. being easy to manufacture and integrate;
2. letting the laminated structures smoothly enter and exit the microwave cavity;
3. having the microwave energy safety value;
4. using environmentally friendly adhesive materials;
5. rapidly heating and solidifying the laminated structure;
6. heating evenly the adhesive in the laminated structure.

Many modifications and other embodiments of the present disclosure set forth herein will come to mind to one skilled in the art to which the present disclosed subject matter pertains having the benefit of the teachings presented in the foregoing descriptions and the associated drawings. Therefore, it is to be understood that the present subject matter is not to be limited to the specific embodiments disclosed and that modifications and other embodiments are intended to be included within the scope of the appended claims. Although specific terms are employed herein, they are used in a generic and descriptive sense only and not for purposes of limitation. It will be understood that various details of the presently disclosed subject matter may be changed without departing from the scope of the presently disclosed subject matter. Furthermore, the foregoing description is for the purpose of illustration only, and not for the purpose of limitation.

### SYMBOL DESCRIPTION

100 continuous microwave curing system, 110 heating cavity,
112a inlet opening, 112b outlet opening, 120 microwave power source,
122 microwave energy, microwave suppression cavity 130,
130a first microwave suppression cavity,
130b second microwave suppression cavity, 132 suppression structure,
135 first wave absorbing structure, 136 second wave absorbing structure,
140 exhaust module, 150 conveyor belt, 155 roller, 180 laminated structure,
190 front operation module, 190a placement mechanism, 190b fixed mechanism

What is claimed is:

1. A continuous microwave curing system, comprising:
a heating cavity, the heating cavity comprising an inlet opening and an outlet opening on opposite sides;
a microwave power source in the heating cavity;
a first microwave suppression cavity, connected to the inlet opening of the heating cavity, containing a plurality of first suppression structures;
a second microwave suppression cavity, connected to the outlet opening of the heating cavity, containing a plurality of second suppression structures;
a conveyor belt, used to transport a laminated structure that needs to be heated by microwave power, configured to enter the first microwave suppression cavity, then enter the heating cavity to heat with the microwave power for a period of time, and finally enter the second microwave suppression cavity and output; and
a microwave absorbing structure, disposed above an interior of the first microwave suppression cavity or the second microwave suppression cavity, and containing at least one microwave absorbing material,
wherein the laminated structure includes at least one adhesive and two layers of objects, and
wherein the at least one adhesive is placed between the two layers of objects.

2. The continuous microwave curing system according to claim 1, further comprising a front operation module, the front operation module comprising:
a placement mechanism for placing the at least one adhesive between the two layers of objects to form the laminated structure; and
a fixing mechanism for fixing the laminated structure to prevent the at least one adhesive from being misaligned with the two layers of objects.

3. The continuous microwave curing system according to claim 1, wherein the microwave absorbing structure is disposed above the interior of the first microwave suppression cavity and the second microwave suppression cavity, and
wherein the microwave absorbing structure comprises:
a plurality of fluid pipelines; and
microwave absorbing materials inside the plurality of fluid pipelines.

4. The continuous microwave curing system according to claim 1, further comprising a soft conductive material on an outermost side of the first microwave suppression cavity and the second microwave suppression cavity.

5. The continuous microwave curing system according to claim 1, further comprising a first soft conductive material suspended at a joint between the first microwave suppression cavity and a joint between the second microwave suppression cavity and the heating cavity.

6. A continuous microwave curing process comprising:
placing an adhesive between two layers of objects to form a laminated structure; and
using a conveyor belt to send the laminated structure into a heating cavity for heating with microwave power for a period of time, so that the temperature of the adhesive reaches above 60 degrees.

7. The continuous microwave curing process according to claim 6, further comprising fixing the laminated structure to prevent misalignment between the adhesive and the two layers of objects.

8. The continuous microwave curing process according to claim 6, wherein the microwave power is between 3 kw and 18 kw, and the period of time is between 10 seconds and 3 minutes.

9. The continuous microwave curing process according to claim 6, wherein the adhesive is a hot melt adhesive.

10. The continuous microwave curing process according to claim 6, wherein the adhesive is a moisture curing reactive polyurethane hot melt adhesive.
